(19) United States
(12) Patent Application Publication
(10) Pub. No.: US 2020/0319993 A1
(43) Pub. Date: Oct. 8, 2020

(54) SERVERS AND COMPUTER PROGRAMS FOR DEBUGGING OF NATIVE PROGRAMS AND VIRTUAL MACHINE PROGRAMS ON INTEGRATED DEVELOPMENT ENVIRONMENT

(71) Applicant: TMAXSOFT CO., LTD, Gyeonggi-do (KR)

(72) Inventors: Seokjun HONG, Gyeonggi-do (KR); Soyoung LEE, Gyeonggi-do (KR); Minseong LEE, Gyeonggi-do (KR); Eunyoung KIM, Gyeonggi-do (KR)

(21) Appl. No.: 16/383,428

(22) Filed: Apr. 12, 2019

(30) Foreign Application Priority Data
Apr. 5, 2019 (KR) 10-2019-0040252

(51) Int. Cl. G06F 11/36; G06F 9/455

(52) U.S. Cl. CPC G06F 11/3624; G06F 2009/45591; G06F 9/45558; G06F 11/3664

(57) ABSTRACT

Disclosed is a server for debugging of virtual machine programs and native programs in an integrated development environment according to some exemplary embodiments of the present disclosure. The server may include: an integrated development environment interface providing unit configured to provide an integrated development environment interface; and an integrated debugging unit configured to provide integrated debugging between the native programs and the virtual machine programs, in which the integrated debugging unit may include a debugging instruction receiving module configured to receive instructions for performing debugging of a first program from the integrated development environment interface, in which the first program comprises the native programs and the virtual machine programs which may be mutually called; and a debugger allocation module configured to allocate a debugger module corresponding to an execution context of the first program to the integrated development environment interface if the debugging instruction receiving module receives the instructions for performing debugging of a first program, in which the corresponding debugger module is the native debugger module or the virtual machine debugger module.

### CROSS-REFERENCE TO RELATED APPLICATIONS

This application claims priority to and the benefit of Korean Patent Application No. 10-2019-0040252 filed in the Korean Intellectual Property Office on Apr. 05, 2019, the entire contents of which are incorporated herein by reference.

### TECHNICAL FIELD

The present disclosure relates to debugging of virtual machine programs and native programs in an integrated development environment.

### BACKGROUND ART

A virtual machine (VM) acquired by implementing a computing environment as software includes software that emulates a computer. The virtual machine may be generally classified into a system virtual machine and a process virtual machine. The system virtual machine has a structure in which a program is executed on respective independent operating systems (OSs) and the process virtual machine has a structure in which the program is executed on a host operating system. Native programs may include the program executed on the operating system.

The native programs and the virtual machine programs may have a mutual calling relationship. For example, referring to FIG. 1, as an interface (e.g., a Java Native Interface (JNI)) of the virtual machine, virtual machine programs (e.g., Java object code) executed by a virtual machine (e.g., JVM) is called by a library implemented by other languages including native application programs and C and C++ and an assembly or the virtual machine programs provides a function to call the library implemented by other languages.

On the integrated development environment, the debugging of the native programs and the virtual machine programs which are mutually called may be performed by individually using debugging of each program as illustrated in FIG. 1. Accordingly, a user (i.e., program developer) needs to directly execute debugger suitable for the corresponding program. Further, the user needs to appropriately switch a debugger according to an execution flow of the corresponding program.

Therefore, there is a demand for a solution in which the debugging of the native programs and the virtual machine programs which are mutually called may be integrally performed in the integrated development environment.

### SUMMARY OF THE INVENTION

The present disclosure has been made in an effort to provide servers and computer programs for debugging of virtual machine programs and native programs in an integrated development environment.

However, technical objects of the present disclosure are not restricted to the technical object mentioned as above. Unmentioned technical objects will be apparently appreciated by those skilled in the art by referencing to the following description.

An exemplary embodiment of the present disclosure provides a server for debugging of virtual machine programs and native programs in an integrated development environment.

The server may include: an integrated development environment interface providing unit configured to provide an integrated development environment interface; and an integrated debugging unit configured to provide integrated debugging between the native programs and the virtual machine programs, in which the integrated debugging unit may include a debugging instruction receiving module configured to receive instructions for performing debugging of a first program from the integrated development environment interface, in which the first program comprises the native programs and the virtual machine programs which may be mutually called; and a debugger allocation module configured to allocate a debugger module corresponding to an execution context of the first program to the integrated development environment interface if the debugging instruction receiving module receives the instructions for performing debugging of a first program, in which the corresponding debugger module is the native debugger module or virtual machine debugger module.

The debugger allocation module may determine the execution context of the first program if the instructions for performing debugging of a first program are received; determine the debugger module corresponding to the determined execution context; and allow for providing debugging by the determined debugger module via the integrated development environment interface.

The debugger allocation module may re-determine the execution context of the first program if a call between the native programs and the virtual machine programs occurs; re-determine the debugger module corresponding to the re-determined execution context; and allow for providing debugging by the re-determined debugger module via the integrated development environment interface.

The debugger allocation module may identify whether the allocated debugger module is connected to the integrated development environment interface; and connect the allocated debugger module to the integrated development environment interface if the allocated debugger module is not connected to the integrated development environment interface.

The server may further include a debugging information storage module and the debugger allocation module may store debugging information about the debugger module allocated to the integrated development environment interface in the debugging information storage module.

The debugger allocation module may transmit the debugging information stored in the debugging information storage module to the debugger module allocated to the integrated development environment interface by the call between the native programs and the virtual machine programs.

The debugging information may include at least one of memory status information, register status information, debugging instruction information, and brake-point information.

The execution context may include programming language information and type information of a program currently being debugged among the first program.

Another exemplary embodiment of the present disclosure provides a non-transitory computer readable medium in which a computer program is stored, wherein the computer program includes instructions which cause a processor of a server to perform a method for debugging native programs and virtual machine programs in an integrated development environment (IDE).

In the non-transitory computer readable medium in which a computer program is stored, the computer program may include instructions which cause a processor of a server to perform a method for debugging native programs and virtual machine programs in an integrated development environment and the method may include: receiving, via a debugging instruction receiving module, instructions for performing debugging of a first program from an integrated development environment interface, in which the first program comprises the native programs and the virtual machine programs which may be mutually called; and allocating, via a debugger allocation module, a debugger module corresponding to an execution context of the first program to the integrated development environment interface if the debugging instruction receiving module receives the instructions for performing debugging of a first program, in which the corresponding debugger module is a debugger module for the native program or a debugger module for the virtual machine program.

The step of allocating the corresponding debugger module to the integrated development environment interface may include: determining, via the debugger allocation module, the execution context of the first program if the debugging instruction receiving module receives instructions for performing debugging of a first program; determining, via the debugger allocation module, the debugger module corresponding to the determined execution context; and allowing, via the debugger allocation module, for providing debugging by the determined debugger module via the integrated development environment interface.

The step of allocating the corresponding debugger module corresponding to the execution context of the first program to the integrated development environment interface may further include: re-determining, via the debugger allocation module, the execution context of the first program if a call between the native programs and the virtual machine programs occurs; re-determining, via the debugger allocation module, the debugger module corresponding to the re-determined execution context; and allowing, via the debugger allocation module, for providing debugging by the re-determined debugger module via the integrated development environment interface.

The step of allocating the corresponding debugger module to the integrated development environment interface may further include: identifying, via the debugger allocation module, whether the allocated debugger module is connected to the integrated development environment interface; and connecting, via the debugger allocation module, the allocated debugger module to the integrated development environment interface if the allocated debugger module is not connected to the integrated development environment interface.

The method may further include storing, via the debugger allocation module, debugging information about the debugger module allocated to the integrated development environment interface in a debugging information storage module.

The debugger allocation module may transmit the debugging information stored in the debugging information storage module to the debugger module allocated to the integrated development environment interface by the call between the native programs and the virtual machine programs.

The debugging information may include at least one of memory status information, register status information, debugging instruction information, and brake-point information.

The execution context may include programming language information and type information of a program currently being debugged among the first program.

Technical solving means which can be obtained in the present disclosure are not limited to the aforementioned solving means and other unmentioned solving means will be clearly understood by those skilled in the art from the following description.

According to exemplary embodiments of the present disclosure, there can be provided servers and computer programs for debugging of virtual machine programs and native programs in an integrated development environment.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a diagram for describing debugging performed in an integrated development environment in the related art.

FIG. 2 illustrates an integrated development environment system according to some exemplary embodiments of the present disclosure.

FIG. 3 is a block diagram of a server for debugging of virtual machine programs and native programs in an integrated development environment according to some exemplary embodiments of the present disclosure.

FIG. 4 is a flowchart for describing an example of a method performed by a server for debugging of virtual machine programs and native programs in an integrated development environment according to some exemplary embodiments of the present disclosure.

FIG. 5 is a flowchart for describing a step of allocating a corresponding debugger module to an integrated development environment interface according to some exemplary embodiments of the present disclosure.

FIG. 6 is another flowchart for describing a step of allocating a corresponding debugger module to an integrated development environment interface according to some exemplary embodiments of the present disclosure.

FIG. 7 is yet another flowchart for describing a step of allocating a corresponding debugger module to an integrated development environment interface according to some exemplary embodiments of the present disclosure.

FIG. 8 is a diagram for describing a means, a logic, a module, and a circuit for debugging of virtual machine programs and native programs in an integrated development environment according to some exemplary embodiments of the present disclosure.

FIG. 9 illustrates a simple and general schematic view of an exemplary computing environment in which the exemplary embodiments of the present disclosure may be implemented.

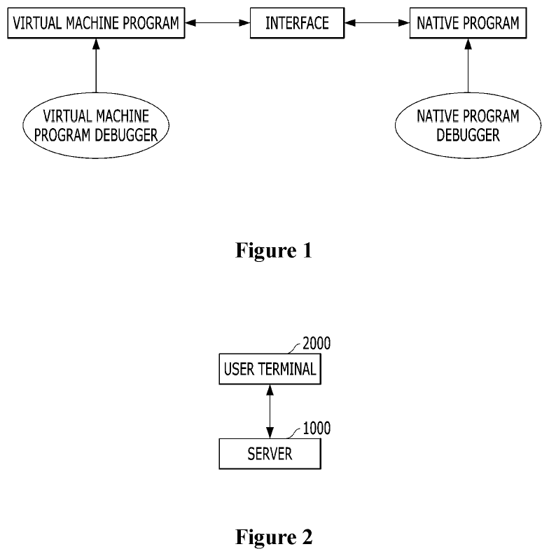

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Various aspects and features will be presented by a system which can include one or more apparatuses, terminals, servers, devices, components, and/or modules. It should also be appreciated and recognized that various systems can include additional apparatuses, terminals, servers, devices, components, and/or modules and/or that the various systems cannot include all of apparatuses, terminals, servers, devices, components, modules, and the like discussed in association with the drawings.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, structures, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application, but such implementation decisions should not be interpreted as causing a departure from the scope of the present disclosure.

“Computer program”, “component”, “module”, “system”, and the like which are terms used in this specification may be used to be compatible with each other and refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers.

The components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

The terminology used in this specification is for the purpose of describing embodiments only and is not intended to limit the present disclosure. In this specification, singular forms include even plural forms unless the context indicates otherwise. It is to be understood that the terms “comprise” and/or “comprising” used in the specification does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to all of the case where X uses A, the case where X uses B, or the case where X uses both A and B. Further, it should be understood that the term “and/or” used in the specification designates and includes all available combinations of one or more items among enumerated related items.

The terms “information” and “data” used in the specification may also be often used to be exchanged with each other.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

FIG. 2 illustrates an integrated development environment system according to some exemplary embodiments of the present disclosure.

The integrated development environment system may provide integrated services related to program development including coding, debugging, compiling, and distribution. Specifically, the integrated development environment system may refer to a system that provides an interactive interface by bundling such programs into one without separately using a compiler, a text editor, or a debugger required for software development. For example, the integrated development environment system may include systems implemented by various platforms including Eclipse, Lazarus, Visual Studio, Delphi, JDE, Popularity of Programming Language (PYPL), Android studio, OF studio, and the like.

According to some exemplary embodiments of the present disclosure, the integrated development environment system may include at least one of a server 1000 and a user terminal 2000. However, components described above are not required in implementing the integrated development environment system and the integrated development environment system may thus have components more or less than components listed above. According to some exemplary embodiments of the present disclosure, the server 1000 may include the user terminal 2000 or the user terminal 2000 may include the server 1000.

The server 1000 and the user terminal 2000 according to some exemplary embodiments of the present disclosure may mutually transmit and receive data for providing the integrated development environment system according to some exemplary embodiments of the present disclosure through a network. For example, the server 1000 and the user terminal 2000 may mutually transmit and receive data for debugging virtual machine programs and native programs.

The network according to the exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network presented here may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

The network according to the exemplary embodiments of the present disclosure may be configured regardless of communication modes such as wired and wireless modes and constituted by various communication networks including a personal area network (PAN), a wide area network (WAN), and the like. Further, the network may be known World Wide Web (WWW) and may adopt a wireless transmission technology used for short-distance communication, such as infrared data association (IrDA) or Bluetooth.

The techniques described in the present specification may also be used in other networks in addition to the aforementioned networks.

According to some exemplary embodiments of the present disclosure, the server 1000 may further include a memory (not illustrated). Here, the memory stores data for supporting various functions of the server 1000. The memory may store multiple application programs (or applications) driven by the server 1000, and data and instructions for operating the server 1000.

At least some of the application programs may be downloaded from an external server through wired/wireless communication. Further, at least some of the application programs may be present in the server 1000 from the time of shipment for basic functions (for example, data conversion, connection with another network via the mainframe or public network, and device sharing) of the server 1000.

Meanwhile, the application program is stored in the memory and installed in the server 1000 to be driven to perform an operation (or function) of the server 1000 by a processor (not illustrated).

The processor generally controls an overall operation of the server 1000. The processor processes a signal, data, information, and the like input or output through the components described above or drives the application program stored in the memory to provide or process information or a function appropriate for the user.

The processor may control at least some of the components of the server 1000 in order to drive the application program stored in the memory. Furthermore, the processor may combine and operate at least two of the components of the server 1000 in order to drive the application program.

At least some of the respective components may operate in cooperation with each other in order to implement the operation, the control, or a control method of the server 1000 according to various exemplary embodiments described below. Further, the operation, the control, or the control method of the server 1000 may be implemented on the server 1000 by driving at least one application program stored in the memory.

According to software-wise implementation, exemplary embodiments such as a procedure and a function described in the present disclosure may be implemented by separate software modules. Each of the software modules may perform one or more functions and operations described in the specification. A software code may be implemented by a software application written by an appropriate program language. The software code may be stored in the memory and executed by the processor.

In the present disclosure, the mainframe as an industrial term referring to a large-sized computer manufactured in a company such as IBM is primarily used in a computing business required for enterprise activities of companies such as large companies or financial institutions and is configured by a centralization scheme rather than a distributed computing scheme. The program of the mainframe may be prepared by a programming language such as COBOL.

In the present disclosure, the user terminal 2000 may be included in an external computing device. Here, the user terminal 2000 may be divided into a mobile/portable terminal and a stationary terminal according to whether the user terminal is movable. Again, the mobile terminal may be divided into a handheld terminal and a vehicle mounted terminal according to whether the user may directly carry the mobile terminal.

For example, the user terminal 2000 may include a cellular phone, a smart phone, a desktop computer, a personal computer, a laptop computer, a digital broadcasting terminal, a digital TV, a digital signage, a personal digital assistants (PDA), a portable multimedia player (PMP), a navigation, a slate PC, a tablet PC, an ultrabook, a wearable device such as a smartwatch, a smart glass, or a head mounted display (HMD)), etc.

According to some exemplary embodiments of the present disclosure, the user terminal 2000 may include the processor and the memory. However, components described above are not required in implementing the user terminal 2000 and the user terminal 2000 may thus have components more or less than components listed above. Here, respective components may be configured as separate chips, modules, or devices and may be included in one device.

The memory of the user terminal 2000 stores data for supporting various functions of the user terminal 2000. Specifically, the memory of the user terminal 2000 may store multiple application programs (or applications) driven by the user terminal 2000 and data and instructions for operating the user terminal 2000.

At least some of the application programs may be downloaded from an external server through wired/wireless communication. Further, at least some of the application programs may be present in the user terminal 2000 from the time of shipment for basic functions (for example, data conversion, connection with another network via the mainframe or public network, and device sharing) of the user terminal 2000.

Meanwhile, the application program is stored in the memory of the user terminal 2000 and installed in the user terminal 2000 to be driven to perform an operation (or function) of the user terminal 2000 by the processor of the user terminal 2000.

The processor of the user terminal 2000 generally controls an overall operation of the user terminal 2000 in addition to an operation related to the control of the user terminal 2000. The processor of the user terminal 2000 processes a signal, data, information, and the like input or output through the components or drives the application program stored in the memory of the user terminal 2000 to provide or process information or a function appropriate for the user.

According to some exemplary embodiments of the present disclosure, the user terminal 2000 may provide the integrated development environment interface to the user through a program (application program) for providing the integrated development environment, which is installed in the user terminal 2000. Various services may be processed which are related to program development such as coding, debug, compiling, distribution, etc., which is requested by the user through the integrated development environment interface.

The integrated development environment system according to the present disclosure may provide a solution in which the debugging of the native programs and the virtual machine programs which are mutually called may be integrally performed in the integrated development environment. The integrated development environment system according to the present disclosure may provide automatic switching of a debugger module (e.g., native debugger module or virtual machine debugger module) suitable to correspond to the programs which may be mutually called. The integrated development environment system of the present disclosure may provide the suitable debugger for the programs that may be mutually called, so that when the native programs and the virtual machine programs are mutually called, the user executes the suitable debugger and directly conforms information for debugging, and modifies a configuration for debugging, thereby avoiding inconvenience of performing a debugging task. The integrated development environment system of the present disclosure may provide an integrated debugging method for programs (virtual machine programs and native programs) that perform debugging using different debuggers.

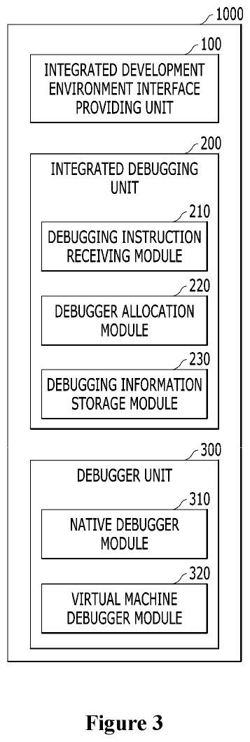

FIG. 3 is a block diagram of a server according to some exemplary embodiments of the present disclosure.

In some exemplary embodiments of the present disclosure, the server 1000 may include an integrated development environment interface providing unit 100, an integrated debugging unit 200, and a debugger unit 300. Of course, in an exemplary embodiment of the present disclosure, the server 1000 may include other components for providing the integrated development environment of the server 1000. The server 1000 may be a terminal or server. For example, the server 1000 may be the server of FIG. 2 and computer programs or instructions for implementing a predetermined process may be executed by the server 1000 for an exemplary embodiment. The server 1000 may include all arbitrary types of devices. As described above, the server 1000 as a digital device may be a digital device with a calculation capability, which has a processor installed therein and a memory, such as a laptop computer, a notebook computer, a desktop computer, a web pad, or a mobile phone.

Components included in the server 1000 may communicate with each other through a network unit (not illustrated). Further, the network unit may include a wired/wireless Internet module. In addition, the network unit includes a short range communication module to transmit and receive data to and from an electronic device positioned at a comparatively short distance from the computing device and including the short range communication module. In an exemplary embodiment of the present disclosure, the network unit may sense a connection status of the network and transmission and reception speeds of the network. Data received through the network unit may be stored through the memory on the server or a persistent storage or transmitted to other electronic devices positioned in a short range through a short-range communication module.

The integrated development environment interface providing unit 100 may provide the integrated development environment interface. For example, the integrated development environment interface providing unit 100 may provide an interface for processing tasks related to program development including coding, debugging, compiling, and distribution. The integrated development environment provided by the integrated development environment interface providing unit 100 may include Eclipse, Lazarus, Visual Studio, Delphi, JDE, Popularity of Programming Language (PYPL), Android studio, and OF studio. However, the present disclosure is not limited thereto and various integrated development environment platforms known in the related art may be used.

The integrated development environment interface providing unit 100 may provide the integrated development environment interface to the user through the user terminal 2000 or the server 1000. The integrated development environment interface providing unit 100 may process various instructions for a program development task. For example, the integrated development environment interface providing unit 100 may process instructions for coding, debugging, compiling, and distribution. The integrated development environment interface providing unit 100 may receive various user instructions for the program development task through the integrated development environment interface. Further, the integrated development environment interface providing unit 100 may provide a processing result of performing a user instruction for the program development task through the integrated development environment interface. However, the present disclosure is not limited thereto and the integrated development environment interface providing unit 100 may perform various operations for the program development task.

The integrated debugging unit 200 may perform various operations for providing integrated debugging between the virtual machine programs and the native programs. For example, the integrated debugging unit 200 may provide the suitable debugger through the integrated development environment interface when the virtual machine programs and the native programs are mutually called.

In some exemplary embodiments, the integrated development environment interface providing unit 100 and the integrated debugging unit 200 may be individual components as illustrated in FIG. 3. In some other exemplary embodiments, the integrated development environment interface providing unit 100 may include the integrated debugging unit 200. In some other exemplary embodiments, the integrated debugging unit 200 may be configured to perform at least some of tasks performed by the integrated development environment interface providing unit 100. However, the present disclosure is not limited thereto and the integrated debugging unit 200 may be configured in various schemes.

In some exemplary embodiments of the present disclosure, the integrated debugging unit 200 may include a debugging instruction receiving module 210, a debugger allocation module 220, and a debugging information storage module 230. Of course, in some exemplary embodiments of the present disclosure, the integrated debugging unit 200 may include other components for providing the integrated debugging between the virtual machine programs and the native programs.

In some exemplary embodiments of the present disclosure, the debugging instruction receiving module 210 may receive a debugging instruction for a first program from the integrated development environment interface. Here, the first program may include programs including the native programs and the virtual machine programs which may be mutually called. For example, while the native programs are executed, the virtual machine programs may be called by a call instruction. Further, while the virtual machine programs are called, the native programs may be called by the call instruction. The native programs and the virtual machine programs which are mutually called by such a scheme may be referred to as the first program.

However, the present disclosure is not limited thereto and the first program may include various programs.

The native programs may include arbitrary program modules implemented by an open frame system (e.g., Unix, Linux, etc.). The native programs may perform functions of the mainframe system implemented through rehosting or perform functions of an open frame computing environment generally used. The native programs may be driven on an operating system and the operating system may include predetermined operating systems of the open system environment. However, the present disclosure is not limited thereto and the native programs may include various programs.

The virtual machine programs may include predetermined program modules implemented on the virtual machine. Specifically, a specific language (e.g., assembly, COBOL, etc.) may be CPU dependent. Therefore, a program implemented in a specific language may not operate on some open frame systems. In this case, instructions of a specific language may be implemented through the virtual machine. A program having such a purpose may be referred to as virtual machine programs. However, the present disclosure is not limited thereto and the virtual machine programs may include various programs.

The debugging execution instruction for the first program may be generated through the integrated development environment interface by an operation of the user. The debugging execution instruction for the first program may be transmitted to the server through the integrated development environment interface. The debugging instruction receiving module 210 may receive the debugging execution instruction for the first program transmitted to the server. In this case, the debugging instruction receiving module 210 may perform various operations for debugging.

In some exemplary embodiments of the present disclosure, the debugging instruction receiving module 210 may control the first program to be executed for debugging. Specifically, when there is an execution request of the first program, the execution request may be a request for simple execution. Further, the execution request may be a request for debugging the first program. For example, the debugging instruction receiving module 1000 may receive the debugging performing instruction for the first program from the integrated development environment interface. In this case, the debugging instruction receiving module 210 may control the first program to be executed for debugging the first program.

The first program may be executed by various components of the server 1000. For example, the first program may be executed by the integrated development environment interface providing unit 100. Further, the first program may be executed by the integrated debugging unit 200. When the first program is executed by the integrated debugging unit, execution of the first program may be execution of the first program for debugging. However, the present disclosure is not limited thereto and the first program may be executed by various components of the server 1000.

In some exemplary embodiments of the present disclosure, when the debugging instruction receiving module 210 receives the debugging instruction, the debugger allocation module 220 may allocate a debugger module corresponding to an execution context of the first program to the integrated development environment interface. Here, the debugger module may be a native debugger module 310 or a virtual machine debugger module 320 included in the debugger unit 300.

The debugger unit 300 may include the native debugger module 310 or the virtual machine debugger module 320. The native debugger module 310 may include various debuggers according to a preparation language of the native programs. For example, the native debugger module may include a debugger module for a program prepared by the Assembly, a debugger module for a program prepared by the COBOL, and a debugger module for a program prepared by the PL/I and the present disclosure is not limited thereto. Further, the virtual machine debugger module 320 may include various debuggers according to the preparation language of the virtual machine programs. For example, the virtual machine debugger module 320 may include the debugger module for the program prepared by the Assembly, the debugger module for the program prepared by the COBOL, and the debugger module for the program prepared by the PL/I and the present disclosure is not limited thereto.

In some exemplary embodiments of the present disclosure, the debugger unit 300 may be an independent component as illustrated in FIG. 3. Further, in some exemplary embodiments of the present disclosure, the debugger unit 300 may be included in the integrated development environment interface providing unit or the integrated debugging unit 200. However, the present disclosure is not limited thereto and the debugger unit 300 may be implemented in various configurations.

As described above, when the debugging instruction receiving module 210 receives the debugging execution instruction, the execution of the first program may be the execution for debugging. In this case, the debugger allocation module 220 may determine an execution context to determine a debugger suitable for debugging the first program.

The execution context may include information on a part to be currently debugged in the first program. For example, the execution context may include type information of a program which is currently debugged in the first program. Specifically, for example, the execution context may include information indicating that the native programs are currently debugged in the first program. As another example, the execution context may include information indicating that the virtual machine programs are currently debugged in the first program. However, the present disclosure is not limited thereto and the execution context may include various information.

The execution context may include information indicating a programming language of the program which is currently debugged. For example, the execution context may include information indicating that the native program which is currently debugged is the program prepared by the COBOL. As another example, the execution context may include information indicating that the virtual machine program which is currently debugged is the program prepared by the Assembly. However, the present disclosure is not limited thereto and the execution context may include various information for determining the debugger suitable for debugging the first program.

When the execution context of the first program is determined, the debugger allocation module 220 may determine a debugger module corresponding to the determined execution context of the first program. For example, the determined execution context of the first program may include information indicating that the currently debugged program is the native program and the native program is the language prepared by the Assembly. In this case, the debugger allocation module 220 may determine a debugger module for an Assembly language in the debugger unit 300 as the debugger module corresponding to the execution context. However, the present disclosure is not limited thereto and the debugger allocation module 220 may determine the debugger module corresponding to the execution context of the first program in various schemes.

When the debugger module corresponding to the determined execution context is determined, the debugger allocation module 220 may allow providing debugging by the determined debugger module in the debugger unit 300 through the integrated development environment interface. For example, the debugger allocation module 220 may determine that the debugger module corresponding to the execution context is a debugger module for the COBOL which is the native programs in the debugger unit 300. In this case, the debugger allocation module 220 may allow for providing a control (or operation) of the debugger module for the COBOL which is the native programs through the integrated development environment interface. Accordingly, a debugging task for the native programs may be performed on the integrated development environment interface through the debugger module for the COBOL which is the native program. When an arbitrary debugger module is allocated to the integrated development environment interface, the allocated debugger module may be controlled through the integrated development environment interface for debugging the first program.

As another example, the debugger allocation module 220 may determine that the debugger module corresponding to the execution context is a debugger module for the Assembly which is the virtual machine program in the debugger unit 300. In this case, the debugger allocation module 220 may allow for providing a control (or operation) of the debugger module for the Assembly which is the virtual machine program through the integrated development environment interface. Accordingly, the debugging task for the native programs may be performed on the integrated development environment interface through the debugger module for the Assembly which is the virtual machine program. However, the present disclosure is not limited thereto and the debugger allocation module 220 may determine to provide the control for the debugger module through the integrated development environment interface in various schemes.

According to some exemplary embodiments of the present disclosure, when the call between the native programs and the virtual machine programs occurs, the debugger allocation module 220 may re-determine the execution context of the first program, re-determine the debugger module corresponding to the re-determined execution context to be re-determined, and allow for providing debugging by the re-determined debugger module through the integrated development environment interface.

Specifically, as described above, the native programs and the virtual machine programs included in the first program may have a mutual calling relationship. For example, while the native programs are being debugged, the virtual machine programs may be called. As another example, while the virtual machine programs are being debugged, the native programs may be called. In this case, the debugger allocation module 220 may determine the debugger module suitable for the called program, and as a result, the program called through the suitable debugger module may be debugged. A detailed description regarding the mutual call between the native programs and the virtual machine programs is disclosed in Korean Patent Registration No. 10-1856486 incorporated in this specification by reference.

The operation of the server performed when the call occurs between the native programs and the virtual machine programs will be described below in detail.

When the call occurs between the native programs and the virtual machine programs, the debugger allocation module 220 may re-determine the execution context of the first program. For example, when the call for the virtual machine programs occurs while debugging the native programs, the debugger allocation module 220 may re-determine the execution context of the first program. For example, the execution context re-determined by the debugger allocation module 220 may include information indicating that the native programs prepared by the COBOL are currently debugged in the first program. As another example, the execution context re-determined by the debugger allocation module 220 may include information indicating that the virtual machine programs prepared by the PL/I are currently debugged in the first program. However, the present disclosure is not limited thereto and the re-determined execution context may include various information.

When the execution context of the first program is re-determined, the debugger allocation module 220 may re-determine a debugger module corresponding to the re-determined execution context of the first program in the debugger unit 300. For example, the re-determined execution context of the first program may include information indicating that the called program is the native program and the called native program is the language prepared by the Assembly. In this case, the debugger allocation module 220 may determine a debugger module for the Assembly language in the debugger unit 300 as the debugger module corresponding to the re-determined execution context. However, the present disclosure is not limited thereto and the debugger allocation module 220 may re-determine the debugger module corresponding to the re-determined execution context in various schemes.

When the debugger module corresponding to the re-determined execution context is determined, the debugger allocation module 220 may allow for providing debugging by the re-determined debugger through the integrated development environment interface. For example, the debugger allocation module 220 may determine that the debugger module corresponding to the re-determined execution context is a debugger module for the COBOL which is the native program. In this case, the debugger allocation module 220 may allow for providing a control (or operation) of the debugger module for the COBOL which is the native program through the integrated development environment interface. Accordingly, the debugging task for the called native program may be performed on the integrated development environment interface through the debugger module for the COBOL which is the native program.

As another example, the debugger allocation module 220 may determine that the debugger module corresponding to the re-determined execution context is the debugger module for the Assembly which is the virtual machine program. In this case, the debugger allocation module 220 may allow for providing the control of the debugger module for the Assembly which is the called virtual machine program through the integrated development environment interface. Accordingly, the debugging task for the called native program may be performed on the integrated development environment interface through the debugger module for the Assembly which is the virtual machine program. However, the present disclosure is not limited thereto and the debugger allocation module 220 may allow for providing the debugging by the debugger module of the called program through the integrated development environment interface in various schemes.

In some exemplary embodiments of the present disclosure, the debugger allocation module 220 may identify whether the allocated debugger module is connected to the integrated development environment interface and when the allocated debugger module is not connected to the integrated development environment interface, the debugger allocation module 220 may connect the allocated debugger module to the integrated development environment interface.

Specifically, the debugger allocation module 220 may identify whether the allocated debugger module is connected to the integrated development environment interface in order to provide the debugging by the debugger module through the integrated development environment interface. For example, the debugger allocation module 220 may determine the debugger module of the native programs prepared by the COBOL to be allocated to the integrated development environment interface. In this case, the allocated debugger module (i.e., debugger module for the COBOL) may be in a connection state to the integrated development environment interface in order to transmit and receive various information (e.g., a debugging instruction, a memory status, a register status, etc.) for debugging. Therefore, the allocated debugger module may receive information for debugging from the integrated development environment interface. Further, the allocated debugger module may receive the information for debugging with the integrated development environment interface. In other words, the allocated debugger module is connected to the integrated development environment interface to perform an operation for debugging for the debugger allocated through the integrated development environment interface, and as a result, the debugging task of the first program may be performed by the allocated debugger.

When the allocated debugger module is already connected to the integrated development environment interface, the debugger allocation module 220 may transmit to the allocated debugger module debugging information related to the previously performed debugging without going through a connection process. Accordingly, the debugging by the allocated debugger module may be performed without a need to perform a connection of the allocated debugger module and the integrated development environment interface. In other words, while there is a connection between any one debugger module (e.g., a native debugger module for the Assembly) included in the debugger unit 300 and the integrated development environment interface and the debugging task by the connected debugger module is performed, another debugger module (e.g., a virtual machine debugger module for the COBOL) may be newly allocated as the call between the native programs and the virtual machine programs occurs. Even when another debugger module is newly allocated, a connection between the previously established debugger module (i.e., a native debugger module for the Assembly) and the integrated development environment interface may be maintained. Therefore, when there is a situation in which the previously connection-established debugger module is allocated again, the debugging task by the re-allocated debugger module may be performed by using the previously established connection.

When the allocated debugger module is not connected to the integrated development environment interface, the debugger allocation module 220 may connect the allocated debugger module to the integrated development environment interface. In this case, the connection of the allocated debugger module and the integrated development environment interface may be performed in various schemes. For example, the connection of the allocated debugger module and the integrated development environment interface may be performed using a socket communication scheme (for example, a socket communication scheme using TCP or UDP). However, the present disclosure is not limited thereto and the connection of the allocated debugger module and the integrated development environment interface may be performed in various schemes.

When a plurality of virtual machines or languages of a plurality of virtual machine programs are used, respective debugger modules may be individually connected to the integrated development environment interface at times when the respective debugger modules are allocated. Accordingly, only a connection of a debugger module for which the debugging task is actually used may be performed. However, the present disclosure is not limited thereto and the connection of the allocated debugger module and the integrated development environment interface may be performed in various schemes.

In some exemplary embodiments of the present disclosure, the debugger allocation module 220 may store the debugging information regarding the debugger module allocated to the integrated development environment interface in the debugging information storage module 230.

When the debugging task is performed through the allocated debugger module, the debugger allocation module 220 may store various information for debugging in the debugging information storage module 230. The debugging information stored in the debugging information storage module 230 may include memory status information, register status information, debugging instruction information, and brake-point information. The memory status information may mean information on a status of the memory during a debugging process. For example, the memory status information may include an address, a type, a data value, and the like of an instruction or a variable. The register status information may mean information on the status of a register during the debugging process. For example, the register status information may include an item, the address, the type, the data value, and the like of the register. The debugging instruction information may mean information on instructions input and processed for debugging. For example, the debugging instruction information may include information on a type, contents, an input time, a processing result, and the like of the input instruction. The brake-point information may mean information indicating a point where the program for debugging is executed or stopped (or interrupted). For example, the brake-point information may include information for stopping execution of the program at any one point (e.g., a 20^{th} line among all 100 lines of a source code) among source codes of the native programs or the virtual machine programs. However, the present disclosure is not limited thereto and the debugging information storage module 230 may store various information for debugging.

In some exemplary embodiments of the present disclosure, the debugger allocation module 220 may transmit the debugging information stored in the debugging information storage module 230 to the debugger module allocated to the integrated development environment interface by the call between the native programs and the virtual machine programs. For example, while the native programs are being debugged, the virtual machine programs may be called. In this case, as described above, the debugger allocation module 220 may allocate the debugger module for the virtual machine programs to the integrated development environment interface. Accordingly, debugging by a newly allocated debugger module may be performed. The debugger allocation module 220 may transmit debugging information related to the debugging task of the debugger module that is previously allocated to the debugger module that is newly allocated by the call (or allows for transmitting the debugging information by the debugging information storage module 230). Accordingly, the debugging task may be consecutively performed by the debugger module which is newly allocated by using the received debugging information.

The server of the present disclosure may provide automatic switching of the debugger module suitable to correspond to the programs which may be mutually called. The server of the present disclosure may provide the suitable debugger for the called program, so that the user executes the suitable debugger when the native programs and the virtual machine programs are called, directly confirms information for debugging, and modifies the configuration for debugging to avoid inconvenience of performing the debugging task. The server of the present disclosure may provide integrated debugging for programs (virtual machine programs and native programs) that perform debugging using different debuggers.

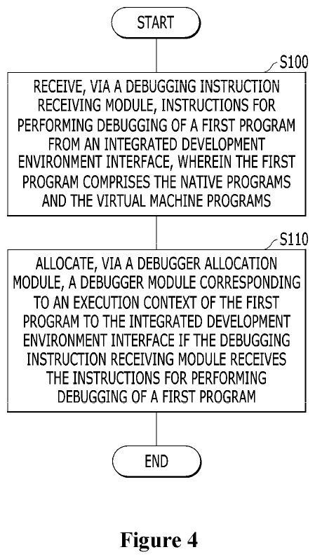

FIG. 4 is a flowchart for describing an example of a method performed by a server for debugging of virtual machine programs and native programs in an integrated development environment according to some exemplary embodiments of the present disclosure.

In some exemplary embodiments of the present disclosure, a method performed by the server 1000 for debugging the virtual machine programs and native programs on the integrated development environment may include a step (s100) of receiving a debugging execution instruction for a first program from the integrated development environment interface by a debugging instruction receiving module 210. Here, the first program may include the native programs and the virtual machine programs which may be mutually called.

In some exemplary embodiments of the present disclosure, the method performed by the server 1000 for debugging the virtual machine programs and native programs on the integrated development environment may include a step (s110) of allocating, by a debugger allocation module 220, a debugger module corresponding to an execution context of the first program to the integrated development environment interface when the debugging instruction receiving module 210 receives the debugging execution instruction. Here, the corresponding debugger module may be a debugger module for the native programs or a debugger module for the virtual machine programs.

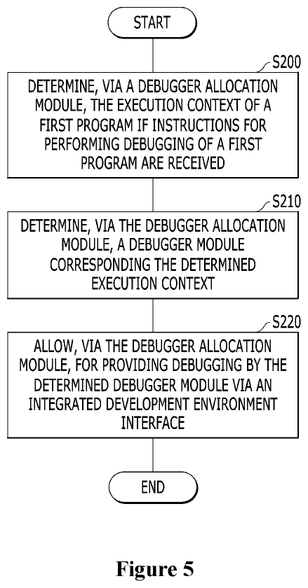

FIG. 5 is a flowchart for describing a step (s110) of allocating a corresponding debugger module to an integrated development environment interface according to some exemplary embodiments of the present disclosure.

In some exemplary embodiments of the present disclosure, when the step (s110) of allocating the corresponding debugger module to the integrated development environment interface may include a step (s200) of determining, by the debugger allocation module 220, the execution context of the first program when the debugging instruction receiving module 210 receives the debugging execution instruction.

In some exemplary embodiments of the present disclosure, the step (s110) of allocating the corresponding debugger module to the integrated development environment interface may include a step (s210) of determining, by the debugger allocation module 220, the debugger module corresponding to the execution context. In some exemplary embodiments of the present disclosure, the step (s110) of allocating the corresponding debugger module to the integrated development environment interface may include a step (s220) of allowing, by the debugger allocation module 220, for providing the debugging by the determined debugger through the integrated development environment interface.

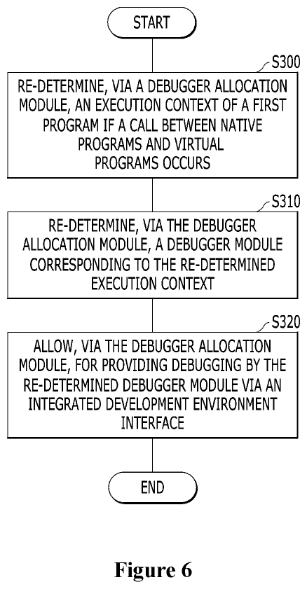

FIG. 6 is yet another flowchart for describing a step of allocating a corresponding debugger module to an integrated development environment interface according to some exemplary embodiments of the present disclosure.

In some exemplary embodiments of the present disclosure, the step (s110) of allocating the corresponding debugger module to the integrated development environment interface may further include a step (s300) of re-determining, by the debugger allocation module 220, the execution context of the first program when the call between the native programs and the virtual machine programs occurs.

In some exemplary embodiments of the present disclosure, the step (s110) of allocating the corresponding debugger module to the integrated development environment interface may further include a step (s310) of re-determining, by the debugger allocation module 220, the debugger module corresponding to the re-determined execution context.

In some exemplary embodiments of the present disclosure, the step (s110) of allocating the corresponding debugger module to the integrated development environment interface may further include a step (s320) of allowing, by the debugger allocation module 220, for providing the debugging by the re-determined debugger through the integrated development environment interface.

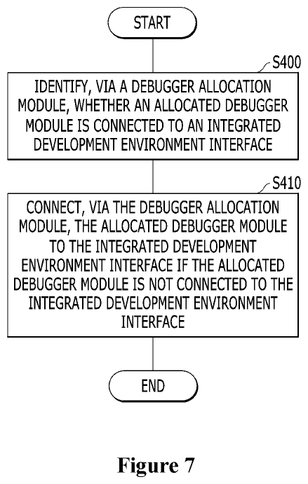

FIG. 7 is yet another flowchart for describing a step of allocating a corresponding debugger module to an integrated development environment interface according to some exemplary embodiments of the present disclosure.

In some exemplary embodiments of the present disclosure, the step (s110) of allocating the corresponding debugger module to the integrated development environment interface may further include a step (s400) of identifying, by the debugger allocation module 220, whether the allocated debugger module is connected to the integrated development environment interface.

In some exemplary embodiments of the present disclosure, the step (s110) of allocating the corresponding debugger module to the integrated development environment interface may further include a step (s410) of connecting, by the debugger allocation module 220, the allocated debugger module to the integrated development environment interface when the allocated debugger module is not connected to the integrated development environment interface.

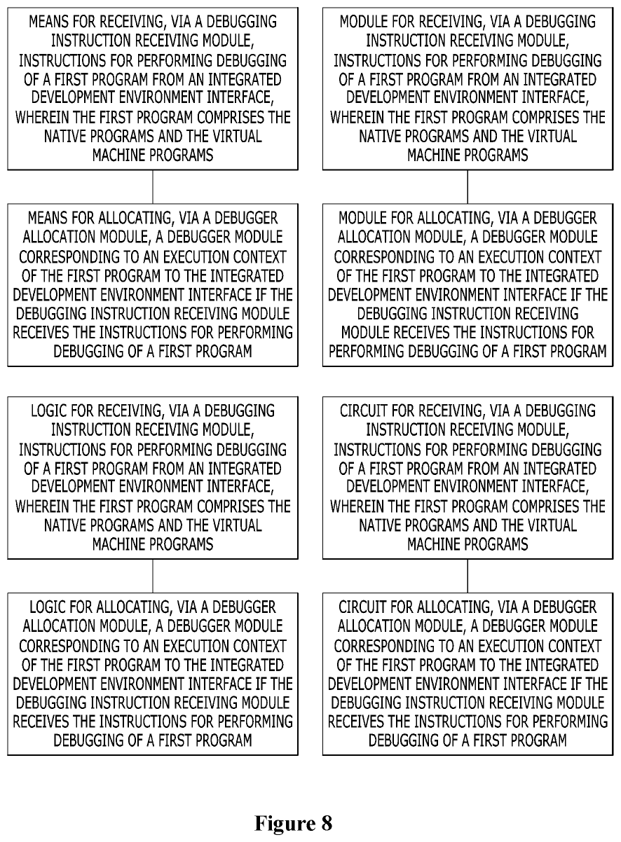

FIG. 8 is a diagram for describing a means, a logic, a module, and a circuit for debugging of virtual machine programs and native programs in an integrated development environment according to some exemplary embodiments of the present disclosure.

In some exemplary embodiments of the present disclosure, a means for debugging virtual machine programs and native programs in an integrated development environment may include a means for receiving, by a debugging instruction receiving module 210, a debugging instruction for a first program from an integrated development environment interface by a debugging instruction receiving module 210. Here, the first program may include the native programs and the virtual machine programs which may be mutually called.

In some exemplary embodiments of the present disclosure, the means for debugging the virtual machine programs and the native programs on the integrated development environment may include a means for allocating, by a debugger allocation module 220, a debugger module corresponding to an execution context of the first program to the integrated development environment interface when the debugging instruction receiving module 210 receives the debugging execution instruction. Here, the corresponding debugger module may be a debugger module for the native programs or a debugger module for the virtual machine programs.

In some exemplary embodiments of the present disclosure, a logic for debugging virtual machine programs and native programs in an integrated development environment may include a logic for receiving, by a debugging instruction receiving module 210, a debugging instruction for a first program from an integrated development environment interface by a debugging instruction receiving module 210. Here, the first program may include the native programs and the virtual machine programs which may be mutually called.

In some exemplary embodiments of the present disclosure, the logic for debugging the virtual machine programs and the native programs on the integrated development environment may include a logic for allocating, by a debugger allocation module 220, a debugger module corresponding to an execution context of the first program to the integrated development environment interface when the debugging instruction receiving module 210 receives the debugging execution instruction. Here, the corresponding debugger module may be a debugger module for the native programs or a debugger module for the virtual machine programs.

In some exemplary embodiments of the present disclosure, a module for debugging virtual machine programs and native programs in an integrated development environment may include a module for receiving, by a debugging instruction receiving module 210, a debugging instruction for a first program from an integrated development environment interface by a debugging instruction receiving module 210. Here, the first program may include the native programs and the virtual machine programs which may be mutually called.

In some exemplary embodiments of the present disclosure, the module for debugging the virtual machine programs and the native programs on the integrated development environment may include a module for allocating, by a debugger allocation module 220, a debugger module corresponding to an execution context of the first program to the integrated development environment interface when the debugging instruction receiving module 210 receives the debugging execution instruction. Here, the corresponding debugger module may be a debugger module for the native programs or a debugger module for the virtual machine programs.

In some exemplary embodiments of the present disclosure, a circuit for debugging virtual machine programs and native programs in an integrated development environment may include a circuit for receiving, by a debugging instruction receiving module, a debugging instruction for a first program from an integrated development environment interface by a debugging instruction receiving module 210. Here, the first program may include the native programs and the virtual machine programs which may be mutually called.

In some exemplary embodiments of the present disclosure, the circuit for debugging the virtual machine programs and the native programs on the integrated development environment may include a circuit for allocating, by a debugger allocation module 220, a debugger module corresponding to an execution context of the first program to the integrated development environment interface when the debugging instruction receiving module 210 receives the debugging execution instruction. Here, the corresponding debugger module may be a debugger module for the native programs or a debugger module for the virtual machine programs.

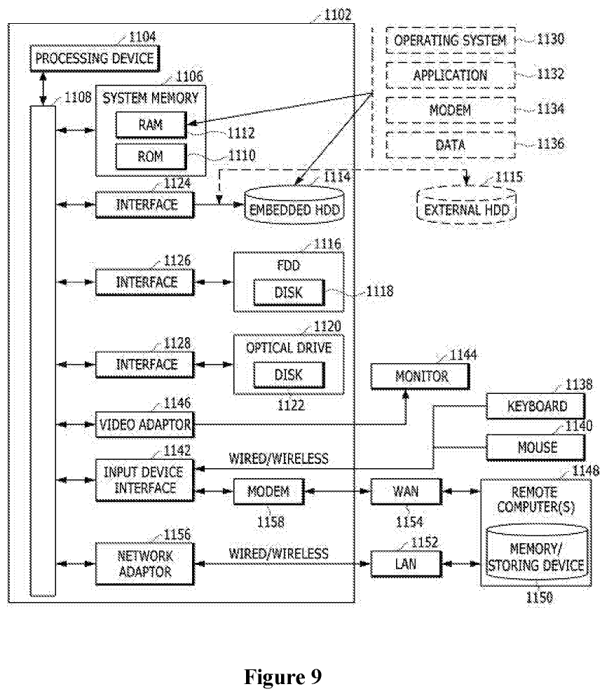

FIG. 9 illustrates a simple and general schematic view of an exemplary computing environment in which the exemplary embodiments of the present disclosure may be implemented.

The present disclosure has generally been described above in association with a computer executable instruction which may be executed on one or more computers, but it will be well appreciated by those skilled in the art that the present disclosure can be implemented through a combination with other program modules and/or a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a mainframe computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media.

The computer readable storage media include volatile and non-volatile media, temporary and non-temporary media, and movable and non-movable media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive (HDD) 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or recorded in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps(802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes computer programs or media which are accessible by a predetermined computer-readable device. For example, a computer readable storage includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” include a wireless channel and various other media that can store, possess, and/or transfer instruction(s) and/or data, but are not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is consistent with the principles and new features presented herein.

1. A server for debugging native programs and virtual machine programs in an integrated development environment (IDE), the server comprising a processor and a memory communicatively coupled with the processor, wherein the processor is configured to implement:
an integrated development environment interface providing unit configured to provide an integrated development environment interface; and
an integrated debugging unit configured to provide integrated debugging between the native programs and the virtual machine programs,
wherein the integrated debugging unit comprises:
a debugging instruction receiving module configured to receive instructions for performing debugging of a first program from the integrated development environment interface, wherein the first program comprises the native programs and the virtual machine programs; and
a debugger allocation module configured to allocate a debugger module corresponding to an execution context of the first program to the integrated development environment interface if the debugging instruction receiving module receives the instructions for performing debugging of the first program;
wherein the debugger module is a native debugger module or a virtual machine debugger module, and
wherein the debugger allocation module:
allocates the native debugger module to the integrated development environments interface if the execution context of the first program relates to the native programs, and
allocates the virtual machine debugger module to the integrated development environment interface if the execution context of the first program relates to the native programs.

2. The server of claim 1, wherein the debugger allocation module:
determines the execution context of the first program if the instructions for performing debugging of the first program are received;
determines the debugger module corresponding to the determined execution context; and
allows for providing debugging by the determined debugger module via the integrated development environment interface.

3. The server of claim 1, wherein the debugger allocation module:
re-determines the execution context of the first program if a call between the native programs and the virtual machine programs occurs;
re-determines the debugger module corresponding to the re-determined execution context; and
allows for providing debugging by the re-determined debugger module via the integrated development environment interface.

4. The server of claim 1, wherein the debugger allocation module:
identifies whether the allocated native debugger module or virtual machine debugger module is connected to the integrated development environment interface; and
connects the allocated native debugger module or virtual machine debugger module to the integrated development environment interface if the allocated native debugger module or virtual machine debugger module is not connected to the integrated development environment interface.

5. The server of claim 1, wherein the integrated debugging unit further comprises a debugging information storage module, and
wherein the debugger allocation module stores debugging information about the allocated native debugger module or virtual machine debugger module in the debugging information storage module.

6. The server of claim 5, wherein the debugger allocation module transmits the debugging information stored in the debugging information storage module to the native debugger module or virtual machine debugger module allocated to the integrated development environment interface by a call between the native programs and the virtual machine programs.

7. The server of claim 5, wherein the debugging information comprises at least one of memory status information, register status information, debugging command information, and brake-point information.

8. The server of claim 1, wherein the execution context comprises programming language information and type information of a program currently being debugged among the first program.

9. A non-transitory computer readable medium in which a computer program is stored, wherein the computer program includes commands which cause a processor of a server to perform a method for debugging native programs and virtual machine programs in an integrated development environment (IDE), the method comprising:
receiving, via a debugging instruction receiving module, instructions for performing debugging of a first program from an integrated development environment interface, wherein the first program comprises the native programs and the virtual machine programs; and
allocating, via a debugger allocation module, a debugger module corresponding to an execution context of the first program to the integrated development environment interface if the debugging instruction receiving module receives the instructions for performing debugging of the first program;
wherein the debugger module is a native debugger module or a virtual machine debugger module, and
wherein the debugger allocation module:
allocates the native debugger module to the integrated development environment interface if the execution context of the first program relates to the native programs, and
allocates the virtual machine debugger module to the integrated development environment interface if the execution context of the first program relates to the native programs.

10. The non-transitory computer readable medium of claim 9, wherein the step of allocating the debugger module corresponding to the execution context of the first program to the integrated development environment interface comprises:
determining, via the debugger allocation module, the execution context of the first program if instructions for performing debugging of the first program are received;
determining, via the debugger allocation module, the debugger module corresponding the determined execution context; and
allowing, via the debugger allocation module, for providing debugging by the determined debugger module via the integrated development environment interface.

11. The non-transitory computer readable medium of claim 9, wherein the step of allocating the debugger module corresponding to the execution context of the first program to the integrated development environment interface comprises:
re-determining, via the debugger allocation module, the execution context of the first program if a call between the native programs and the virtual machine programs occurs;
re-determining, via the debugger allocation module, the debugger module corresponding to the re-determined execution context; and
allowing, via the debugger allocation module, for providing debugging by the re-determined debugger module via the integrated development environment interface.

12. The non-transitory computer readable medium of claim 9, wherein the step of allocating the debugger module corresponding to the execution context of the first program to the integrated development environment interface comprises:
identifying, via the debugger allocation module, whether the allocated native debugger module or virtual machine debugger module is connected to the integrated development environment interface; and
connecting, via the debugger allocation module, the allocated native debugger module or virtual machine debugger module to the integrated development environment interface if the allocated native or virtual machine debugger module is not connected to the integrated development environment interface.

13. The non-transitory computer readable medium of claim 9, the method further comprising:
storing, via the debugger allocation module, debugging information about the allocated native debugger module or virtual machine debugger module in a debugging information storage module.

14. The non-transitory computer readable medium of claim 13, wherein the debugger allocation module transmits the debugging information stored in the debugging information storage module to the native debugger module or virtual machine debugger module allocated to the integrated development environment interface by a call between the native programs and the virtual machine programs.

15. The non-transitory computer readable medium of claim 13, wherein the debugging information comprises at least one of memory status information, register status information, debugging command information, and brake-point information.

16. The non-transitory computer readable medium of claim 9, wherein the execution context comprises programming language information and type information of a program currently being debugged among the first program.
